(19) United States
(12) Patent Application Publication
(10) Pub. No.: US 2026/0336107 A1
(43) Pub. Date: Oct. 29, 2026

(54) ITEM TRANSFER DEVICE FOR ROBOT

(71) Applicants: Hyundai Motor Company, Seoul (KR); Kia Corporation, Seoul (KR)

(72) Inventors: Jooyoung Chun, Hwaseong-si (KR); Geunsang Yu, Hwaseong-si (KR); Kyungmin Kim, Hwaseong-si (KR); Jaehyuk Choi, Hwaseong-si (KR); Jea Kyoo An, Seoul (KR)

(21) Appl. No.: 19/535,406

(22) Filed: Feb. 10, 2026

(30) Foreign Application Priority Data
Apr. 28, 2025 (KR) 10-2025-0055282

(51) Int. Cl. B25J 9/16; B25J 15/00; B25J 19/00

(52) U.S. Cl. CPC B25J 9/1638; B25J 15/0033; B25J 19/0091

(57) ABSTRACT

In an embodiment a robot includes a tray configured for receiving an item, a pendulum portion supporting the tray and maintaining the tray in a vertical direction with respect to a gravity direction, a hinge portion, supporting the pendulum portion at an upper end of the pendulum portion, and being connected to hingedly-rotate the pendulum portion, and a supportive structure connected to the hinge portion.

### CROSS-REFERENCE TO RELATED APPLICATIONS

This application claims the benefit of and priority to Korean Patent Application No. 10-2025-0055282 filed with the Korean Intellectual Property Office on Apr. 28, 2025, the entire contents of which are incorporated herein by reference.

### TECHNICAL FIELD

The present disclosure relates to an item transfer device for a robot, and more particularly, the present disclosure relates to an item transfer device for a robot for reducing instability generated based on operating a robot by applying a pendulum and a damper in a robot for transferring items.

### BACKGROUND

Recently, the vehicle industry has introduced a new concept of future mobility vision for realizing a dynamic human-centered future city. One of these future mobility solutions is a purpose-built vehicle (PBV) as a purpose-based mobility.

An example of the PBV may be an electric vehicle (EV)-based environment-friendly mobile vehicle. The PBV may provide a variety of customized services to users while traveling from an origin to a destination in an unmanned or manned autonomous driving manner.

Particularly, research on unmanned delivery robots is also actively underway. In the case of unmanned delivery robots based on existing technology, items are delivered to the user, and the user picks them up. However, for example, if the item is a beverage, there is a problem that the beverage overflows due to disturbances (steps, slopes, driving inertia, etc.) that occur during the robot's driving process during the delivery of the beverage. To address this, measures such as double-sealing the beverage container itself are being taken. However, these measures do not fundamentally solve problems such as overflow of beverages or damage to containers, so there is a desire to develop technology to improve the robustness and stability of the transfer mechanism mounted on the unmanned delivery robot.

### SUMMARY

Embodiments of the present disclosure provide an item transfer device for a robot for maintaining a horizontal state of an item using a pendulum connected to a lower portion of a tray, and preventing impacts and damages applied to the item using a damper in an item transfer device mounted on a delivery robot, to facilitate maintaining stability and robustness.

An embodiment of the present disclosure provides an item transfer device for a robot including: a tray for receiving an item; a pendulum portion for supporting the tray and allowing the tray to maintain a vertical direction with respect to a gravity direction; a hinge portion supporting the pendulum portion at an upper end of the pendulum portion, and connected for the pendulum portion to be hinge-rotated; and a supportive structure connected to support the hinge portion.

The tray may have a quadrangular plate shape.

The tray may be a cup holder in which circular openings are formed.

The pendulum portion may include: a supporting plate connected to a lower surface of a center of the tray and supporting the tray; and a pendulum mounting portion extending downward from the supporting plate, and including a lower end on which a pendulum is mounted.

The pendulum mounting portion may have a circular cylinder shape, and may have a lower end on which an upper step portion and a lower step portion are formed so that the pendulum is mounted and does not leave.

The pendulum may have a donut shape to be attachable to an exterior circumferential surface of the pendulum mounting portion between the upper step portion and the lower step portion.

The pendulum may be made of a material that is heavier than an entire weight of the item received in the tray.

The hinge portion may include: a first hinge shaft part combined in a surrounding and hinge-rotatable manner to respective exterior circumferential surfaces of the pendulum mounting portion at the lower portion of the supporting plate, and allowing the pendulum portion to be hinge-rotated in the first direction; a second hinge shaft part combined in a surrounding and hinge-rotatable manner to a second hinge shaft formed on respective exterior circumferential surfaces of the first hinge portion part, and allowing the pendulum portion to be hinge-rotated in a second direction that is vertical to the first direction; a second hinge shaft fixing part combined to be hinge-rotated on a third hinge shaft formed on respective exterior circumferential surfaces of the second hinge shaft part, allowing the pendulum portion to be hinge-rotated in the first direction, and supporting the second hinge shaft part; and a second hinge shaft fixing part rack supporting a lower surface of the second hinge shaft fixing part and supported by the supportive structure.

The second hinge shaft fixing part may be formed of a pair facing each other at respective sides of the second hinge shaft part.

The second hinge shaft fixing part rack may have a quadrangular plate shape.

The supportive structure may include legs supporting the hinge portion, and the legs may extend in a direction with an angle of 45° with respect to the first direction and the second direction.

The supportive structure may be bent and extend in a direction away from the central axis of the hinge portion toward the gravity direction.

The supportive structure may have four legs, and the four legs may be arranged to surround the pendulum.

The four legs may be connected to each other at the lower end, and a connected portion may be supported by a base plate.

The item transfer device for a robot may further include a damper portion reducing vibration of the pendulum portion and the tray connected thereto based on the pendulum portion being hinge-rotated with respect to the supportive structure.

The damper portion may include: a bracket fixed to an exterior circumferential surface of the pendulum mounting portion at the lower portion of the second hinge shaft part and installed to extend across between the pair of second hinge shaft fixing parts; an upper instrument fixed to the lower portion of the bracket and extending in a vertical direction to the length direction of the bracket; a lower instrument fixed to the upper portion of the second hinge shaft fixing part rack, and extending in parallel to the upper instrument with a gap therebetween; and a wire spring installed between the upper instrument and the lower instrument, and formed to have ring shapes arranged in parallel along the length directions of the upper instrument and the lower instrument.

The upper instrument, the lower instrument, and the wire spring may be provided as a pair symmetrically arranged to each other at the respective lower ends of the bracket.

According to an embodiment, a low mass center may be secured by using the pendulum connected to the lower portion of the tray in the item transfer device mounted on a delivery robot, and system stability may be secured by maintaining the horizontal state of the item based on tilting due to steps, slopes, driving inertia, etc.

By adding the damper configured with the fixture and the wire rope on the upper part of the pendulum, the impact applied to the item may be mitigated and damage to the item may be prevented.

### BRIEF DESCRIPTION OF THE DRAWINGS

FIG. 1 shows an item transfer device for a robot according to an embodiment.

FIG. 2 shows a combined state of a tray and a pendulum portion of an item transfer device for a robot according to an embodiment.

FIG. 3 shows a combined state of a pendulum portion of an item transfer device for a robot and a first hinge shaft part of a hinge portion according to an embodiment.

FIG. 4 shows a combined state of a pendulum portion of an item transfer device for a robot and a second hinge shaft part of a hinge portion according to an embodiment.

FIG. 5 shows a combined state of a pendulum portion of an item transfer device for a robot and a second hinge shaft fixing part of a hinge portion according to an embodiment.

FIG. 6 shows a combined state of a pendulum portion of an item transfer device for a robot and a second hinge shaft fixing part rack of a hinge portion according to an embodiment.

FIG. 7 shows a state in which a pendulum portion of an item transfer device for a robot according to an embodiment is parallel to a surface of the earth.

FIG. 8 shows a state in which a pendulum portion of an item transfer device for a robot according to an embodiment is rotated in a first direction with respect to a first hinge shaft part.

FIG. 9 shows a state in which a pendulum portion of an item transfer device for a robot according to an embodiment is rotated in a second direction with respect to a second hinge shaft part.

FIG. 10 shows a state in which a pendulum portion of an item transfer device for a robot according to an embodiment is rotated in first and second directions with respect to first and second hinge shaft parts.

FIG. 11 shows that a bracket of a damper portion of an item transfer device for a robot according to an embodiment is installed.

FIG. 12 shows that an upper instrument of a damper portion of an item transfer device for a robot according to an embodiment is installed.

FIG. 13 shows that a lower instrument of a lower instrument of a damper portion of an item transfer device for a robot according to an embodiment and a wire spring are installed.

FIG. 14 shows that an upper instrument, a lower instrument, and a wire spring are installed on respective lower ends of a bracket of a damper portion of an item transfer device for a robot according to an embodiment.

### DETAILED DESCRIPTION OF ILLUSTRATIVE EMBODIMENTS

The present disclosure will be described more fully hereinafter with reference to the accompanying drawings, in which embodiments of the disclosure are shown. As those skilled in the art will realize, the described embodiments may be modified in various different ways without departing from the spirit or scope of the present disclosure.

Furthermore, with exemplary embodiments of the present disclosure, detailed description is made as to the constituent elements in the first exemplary embodiment with reference to the relevant drawings by using the same reference numerals for the same constituent elements, while only constituent elements that are different from those related to the first exemplary embodiment are described in other exemplary embodiments.

The drawings are schematic and are not illustrated in accordance with a scale. The relative sizes and ratios of the parts in the drawings are exaggerated or reduced for clarity and convenience in the drawings, and an arbitrary size is only exemplary and is not limited. The same structures, elements, or parts illustrated in no less than two drawings are denoted by the same reference numerals in order to represent similar characteristics. When a part is referred to as being “on” another part, it can be directly on the other part or intervening parts may also be present.

An embodiment of the present disclosure will now be illustrated in detail. As a result, various modifications are expected to be made. Therefore, the embodiment is not limited to a specific shape of an illustrated region, but, for example, includes a change in the shape in accordance with manufacturing.

An item transfer device for a robot according to an embodiment will now be described with reference to accompanying drawings.

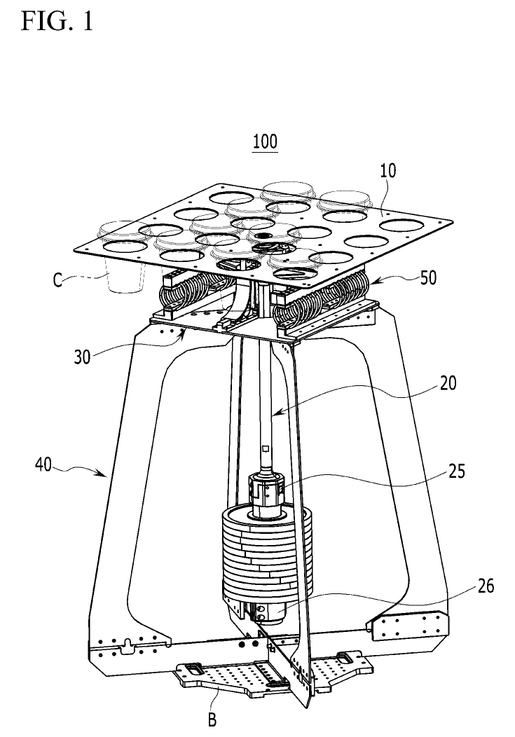

FIG. 1 shows an item transfer device for a robot according to an embodiment.

Referring to FIG. 1, the item transfer device for a robot 100 may include a tray 10, a pendulum portion 20, a hinge portion 30, and a supportive structure 40.

The tray 10 is disposed at an upper end of the item transfer device for a robot 100 and is equipped to directly place items. The tray 10 may be formed in a quadrangular plate shape. The tray 10 may have a shape in which circular openings are formed in parallel. This circular opening may function as a cup (C) holder.

The pendulum portion 20 may support the lower surface of the tray 10 and may enable the tray 10 to maintain at being vertical direction to the gravity direction, that is, parallel to the surface of the earth. For this purpose, the pendulum portion 20 may have a material having a predetermined weight, i.e., a weight that is greater than the total weight of the items put in the tray 10. Therefore, the tray 10 may more easily maintain to be parallel to the surface of the earth.

The hinge portion 30 may be connected so that it may support the pendulum portion bon the upper end of the pendulum portion 20 and the pendulum portion 20 is hinge-rotated. The hinge portion 30 may include hinge shaft parts 32 and 34, and the pendulum portion 20 and the tray 10 connected thereto may be hinge-rotated in a first direction and a second direction perpendicular to the first direction due to the hinge shaft parts 32 and 34.

The supportive structure 40 may be connected to support the hinge portion 30. The supportive structure 40 may be formed to surround the pendulum portion 20 and may be spaced apart from the pendulum (P) by a predetermined interval, and may be made up of legs 42 having the same shape. The legs 42 may be connected together at the lower end, and a connection area may be supported by the base plate (B). The base plate (B) may be mounted inside the transfer robot.

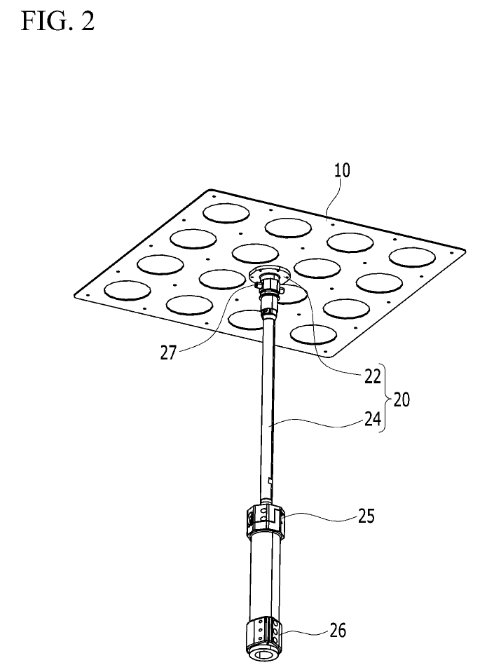

FIG. 2 shows a combined state of a tray and a pendulum portion of an item transfer device for a robot according to an embodiment.

Referring to FIG. 2, the pendulum portion 20 may include a supporting plate 22 and a pendulum mounting portion 24.

The supporting plate 22 may be connected to a lower surface of a center of the tray 10 and may support the tray 10. The pendulum mounting portion 24 may be connected to a lower surface of the supporting plate 22, may extend downward from the supporting plate 22, and a pendulum (P) may be mounted on a lower end.

The pendulum mounting portion 24 may be formed in the shape of a long circular cylinder, and an upper step portion 25 and a lower step portion 26 may be formed at the lower portion of the pendulum mounting portion 24. The upper step portion 25 and the lower step portion 26 may be formed to have radii greater than the radius of the circular cylinder of the upper portion of the pendulum mounting portion 24, and a predetermined interval may be spaced between the upper step portion 25 and the lower step portion 26.

The pendulum (P) may be detached between the upper step portion 25 and the lower step portion 26. The pendulum (P) may be formed in a donut shape so that it may be detachably attached to the exterior circumferential surface of the pendulum mounting portion 24. The pendulum (P) may be provided with members so that the total weight may be adjusted as needed. Either or both of the upper step portion 25 and the lower step portion 26 may be separated and engaged from the pendulum mounting portion 24, and the pendulum (P) may be mounted and engaged after being separated from the pendulum mounting portion 24.

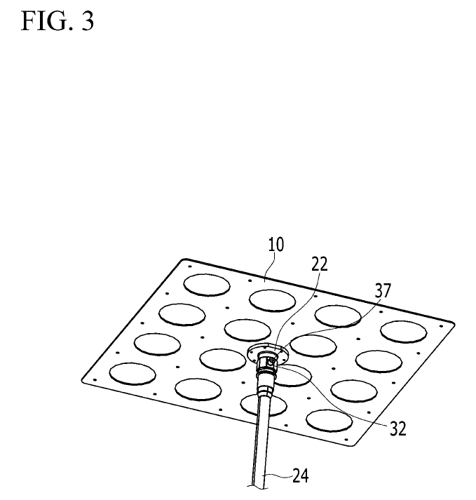

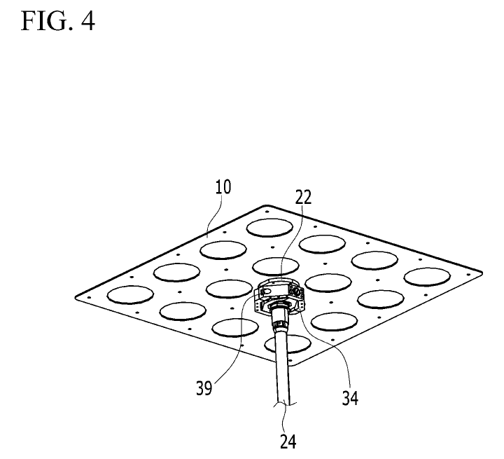

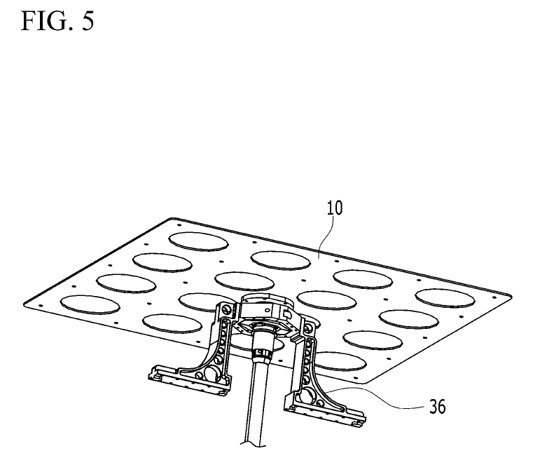

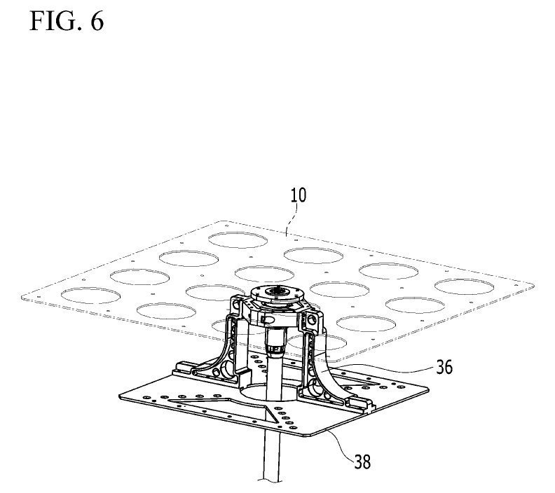

FIG. 3 shows a combined state of a pendulum portion of an item transfer device for a robot and a first hinge shaft part of a hinge portion according to an embodiment, FIG. 4 shows a combined state of a pendulum portion of an item transfer device for a robot and a second hinge shaft part of a hinge portion according to an embodiment, FIG. 5 shows a combined state of a pendulum portion of an item transfer device for a robot and a second hinge shaft fixing part of a hinge portion according to an embodiment, and FIG. 6 shows a combined state of a pendulum portion of an item transfer device for a robot and a second hinge shaft fixing part rack of a hinge portion according to an embodiment.

The hinge portion 30 may be installed at the upper portion of the pendulum portion 20 so that the pendulum portion 20 and the tray 10 may be hinge-rotated. The hinge portion 30 may include a first hinge shaft part 32, a second hinge shaft part 34, a second hinge shaft fixing part 36, and a second hinge shaft fixing part rack 38.

As shown in FIG. 3, the first hinge shaft part 32 may be combined in a surrounding and hinge-rotatable manner to the first hinge shaft 27 shown in FIG. 2 formed on the respective exterior circumferential surfaces of the pendulum mounting portion 24 in the lower portion of the supporting plate 22 so that the pendulum portion 20 and the tray 10 may be hinge-rotated in the first direction by the first hinge shaft part 32 with respect to the first hinge shaft 27. The respective exterior circumferential surfaces of the first hinge shaft part 32 may be provided with a second hinge shaft 37.

As shown in FIG. 4, the second hinge shaft part 34 may be combined to the second hinge shaft 37 in a form that wraps around it so as to be hinge-rotated, and the pendulum portion 20 and the tray 10 may be hinge-rotated in a second direction that is perpendicular to the first direction by the second hinge shaft part 34 with respect to the second hinge shaft 37. A third hinge shaft 39 may be provided on the respective exterior circumferential surfaces of the second hinge shaft part 34.

As shown in FIG. 5, the second hinge shaft fixing part 36 is hinge-rotatably combined to the third hinge shaft 39, and the pendulum portion 20 and the tray 10 may be hinge-rotated in the first direction. The second hinge shaft fixing part 36 may support the second hinge shaft part 34, and the bottom surface of the lower portion may be formed to have a wide area so that it may stably contact and be connected with the upper surface of the second hinge shaft fixing part rack 38. The second hinge shaft fixing part 36 may be formed as a pair facing each other on both sides of the second hinge shaft part 34.

As shown in FIG. 6, the second hinge shaft fixing part rack 38 may support the lower surface of the second hinge shaft fixing part 36, and the lower surface may be supported by the supportive structure 40. The second hinge shaft fixing part rack 38 may be formed to have a quadrangular plate shape, and an opening may be formed in the central portion of the second hinge shaft fixing part rack 38, so that the pendulum mounting portion 24 may pass through the opening and may extend to the lower portion.

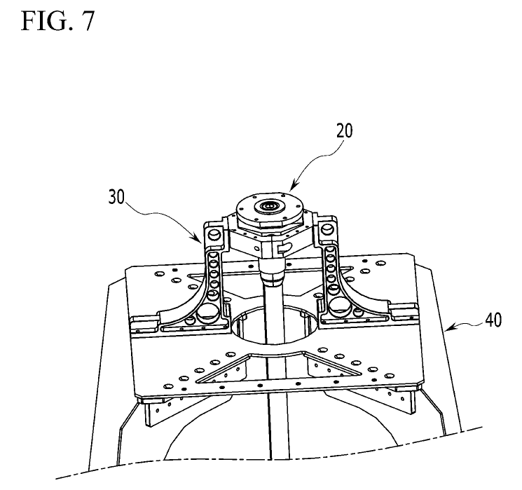

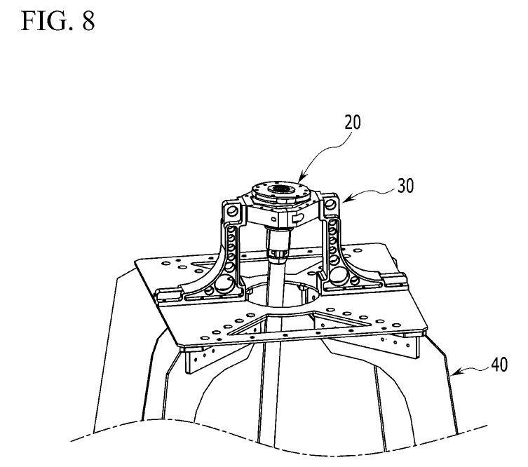

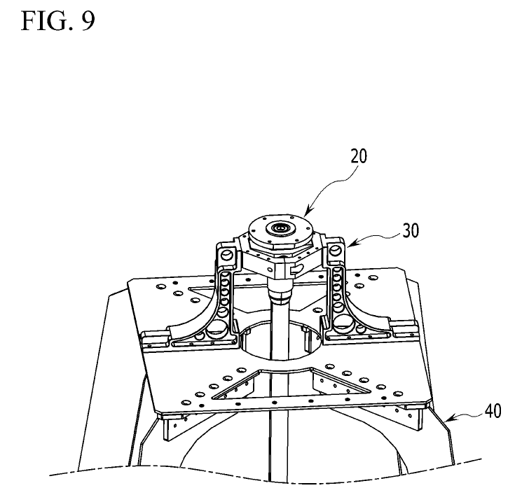

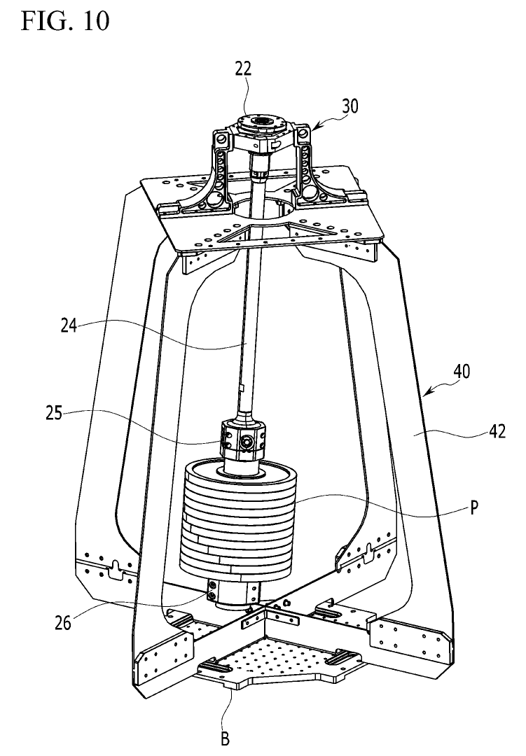

FIG. 7 shows a state in which a pendulum portion of an item transfer device for a robot according to an embodiment is parallel to a surface of the earth, FIG. 8 shows a state in which a pendulum portion of an item transfer device for a robot according to an embodiment is rotated in a first direction with respect to a first hinge shaft part 32, FIG. 9 shows a state in which a pendulum portion of an item transfer device for a robot according to an embodiment is rotated in a second direction with respect to a second hinge shaft part, and FIG. 10 shows a state in which a pendulum portion of an item transfer device for a robot according to an embodiment is rotated in first and second directions with respect to first and second hinge shaft parts.

As shown in FIG. 7, based on the delivery robot being stationary or there is no disturbance (step, slope, driving inertia, etc.) occurring during driving, the pendulum portion 20 of the item transfer device for a robot 100 remains parallel to the surface of the earth. The hinge portion 30 is not rotated, and the tray 10 is maintained horizontal to the surface of the earth.

As shown in FIG. 8, based on a disturbance in the first direction, which occurs during driving, the pendulum portion 20 may be rotated in the first direction with respect to the first hinge shaft part 32. In this case, the first hinge shaft part 32 may be hinge-rotated with respect to the first hinge shaft 27, and the pendulum portion 20 and the tray 10 may be hinge-rotated in the first direction with respect to the first hinge shaft 27. The pendulum portion 20 may be further rotated in the first direction with respect to the second hinge shaft fixing part 36. The second hinge shaft fixing part 36 may be hinge-rotated with respect to the third hinge shaft 39.

Also, as shown in FIG. 9, based on a disturbance in the second direction approximately perpendicular to the first direction that occurs during driving, the pendulum portion 20 may be hinge-rotated with respect to the second hinge shaft 37, and the pendulum portion 20 and the tray 10 may be hinge-rotated with respect to the second hinge shaft 37 in the second direction perpendicular to the first direction.

As shown in FIG. 10, based on a disturbance in the first direction and the second direction during driving, the pendulum portion 20 may be hinge-rotated in the first direction with respect to the first hinge shaft 27 and the third hinge shaft 39, and may be hinge-rotated in the second direction with respect to the second hinge shaft 37.

In FIGS. 8 to 10, the case where the pendulum portion 20 is rotated in the first direction and the second direction by the first hinge shaft part 32 and the second hinge shaft part 34 of the hinge portion 30 is described as an example, but it is also possible to increase the degree of freedom so that it may be rotated in various directions by diversifying the hinge shaft part of the hinge portion 30.

Meanwhile, as shown in FIG. 10, the supportive structure 40 may support the lower surface of the second hinge shaft fixing part rack 38 of the hinge portion 30, and may be formed of legs 42.

The legs 42 may extend in a direction having an angle of approximately 45° with respect to the first direction and the second direction. The legs 42 may be bent and extend in a direction away from the central axis of the hinge portion 30 toward the gravity direction. The legs 42 include four legs 42, and the four legs 42 may be arranged to surround the pendulum (P). The four legs 42 may be connected to each other at the lower end, and the connection part may be supported by the base plate (B).

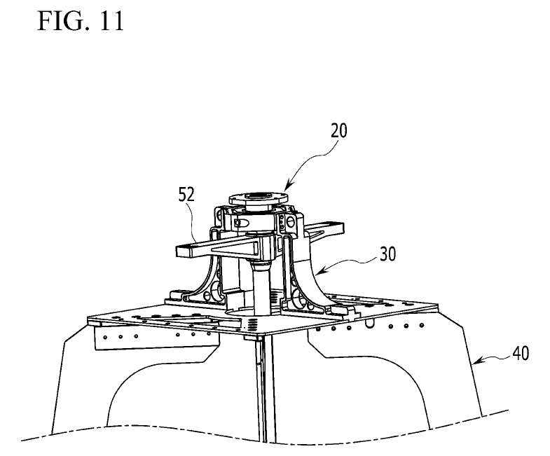

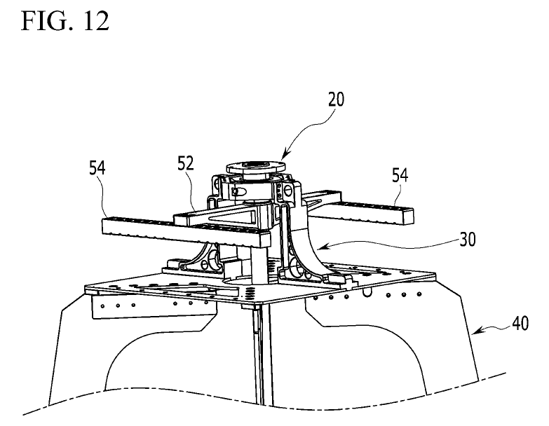

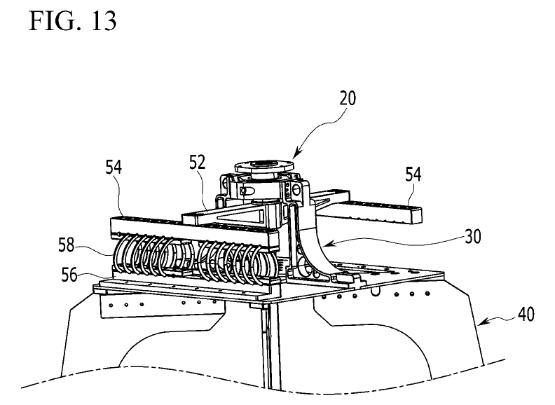

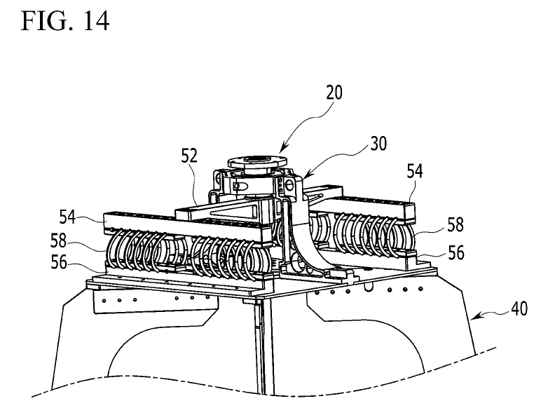

FIG. 11 shows that a bracket of a damper portion of an item transfer device for a robot according to an embodiment is installed, FIG. 12 shows that an upper instrument of a damper portion of an item transfer device for a robot according to an embodiment is installed, FIG. 13 shows that a lower instrument of a lower instrument of a damper portion of an item transfer device for a robot according to an embodiment and a wire spring are installed, and FIG. 14 shows that an upper instrument, a lower instrument, and a wire spring are installed on respective lower ends of a bracket of a damper portion of an item transfer device for a robot according to an embodiment.

The item transfer device for a robot may further include a damper portion 50 reducing vibration of the pendulum portion 20 and the tray 10 connected thereto based on the pendulum portion 20 being hinge-rotated with respect to the supportive structure 40.

The damper portion 50 may include a bracket 52, an upper instrument 54, a lower instrument 56, and a wire spring 58.

As shown in FIG. 11, the bracket 52 may be fixed to the exterior circumferential surface of pendulum mounting portion 24 at the lower portion of the second hinge shaft part 34 and may be installed to extend across between the pair of the second hinge shaft fixing parts 36.

As shown in FIG. 12, the upper instrument 54 may be fixed to the lower end of the bracket 52 and may be installed to extend in a vertical direction to the length direction of the bracket 52. The upper portion instrument 54 may be installed to extend symmetrically and parallel to each other at the respective lower ends of the bracket 52.

As shown in FIG. 13, the lower instrument 56 may be fixed to the upper end of the second hinge shaft fixing part rack 38 and may be installed to extend in parallel to the upper instrument 54 with a gap therebetween. The lower portion instrument 56 may be installed to extend symmetrically and in parallel to each other at the respective upper ends of the second hinge shaft fixing part rack 38.

A wire spring 58 formed in ring shapes arranged in parallel to the length directions of the upper instrument 54 and the lower instrument 56 may be installed between the upper instrument 54 and the lower instrument 56. Upper ends and lower ends of the wire springs 58 may be connected to the upper instrument 54 and the lower instrument 56, respectively, and may be made of elastic materials. The wire springs 58 may perform a damping function by providing elastic force to maintain a constant distance between the upper structure 54 and the lower structure 56 based on the pendulum portion 20 being rotated by the hinge portion 30.

The combined structure of the upper instrument 54, the lower instrument 56, and the wire spring 58 as described above may be provided as a pair symmetrically arranged to each other at the respective lower ends of the bracket 52, so as to absorb impact and vibration caused by disturbance during driving of the delivery robot.

In this way, according to an embodiment, the low mass center may be secured by using the pendulum connected to the lower portion of the tray in the item transfer mechanism mounted on the delivery robot, and system stability may be secured by maintaining the horizontal state of the item based on tilting due to steps, slopes, driving inertia, etc.

Additionally, by adding the damper including a fixture and a wire rope to the upper part of the pendulum, the impact applied to the item may be mitigated and damage to the item may be prevented.

While this disclosure has been described in connection with what is presently considered to be practical embodiments, it is to be understood that the closure is not limited to the disclosed embodiments.

What is claimed is:

1. A robot comprising:
a tray configured for receiving an item;
a pendulum portion supporting the tray and configured to maintain the tray in a vertical direction with respect to a gravity direction;
a hinge portion, supporting the pendulum portion at an upper end of the pendulum portion, and being connected to hingedly-rotate the pendulum portion; and
a supportive structure connected to the hinge portion.

2. The robot of claim 1, wherein the tray has a quadrangular plate shape.

3. The robot of claim 1, wherein the tray is a cup holder comprising circular openings.

4. The robot of claim 1, wherein the pendulum portion comprises:
a supporting plate connected to a lower surface of a center of the tray and supporting the tray, and
a pendulum mounting portion extending downward from the supporting plate, and including a lower end on which a pendulum is mounted.

5. The robot of claim 4,
wherein the pendulum mounting portion has a circular cylinder shape and has a lower end comprising an upper step portion and a lower step portion, and
wherein the pendulum is mounted to the lower end.

6. The robot of claim 5, wherein the pendulum has a donut shape attached to an exterior circumferential surface of the pendulum mounting portion between the upper step portion and the lower step portion.

7. The robot of claim 4, wherein the pendulum comprises a material that is heavier than an entire weight of the item receivable in the tray.

8. The robot of claim 4, wherein the hinge portion comprises:
a first hinge shaft part coupled in a hinge-rotatable manner to respective exterior circumferential surfaces of the pendulum mounting portion at a lower portion of the supporting plate, and allowing the pendulum portion to be hinge-rotated in a first direction,
a second hinge shaft part coupled in a hinge-rotatable manner to a second hinge shaft formed on respective exterior circumferential surfaces of the first hinge shaft part, and allowing the pendulum portion to be hinge-rotated in a second direction that is vertical to the first direction,
a second hinge shaft fixing part combined to be hinge-rotated on a third hinge shaft formed on respective exterior circumferential surfaces of the second hinge shaft part, allowing the pendulum portion to be hinge-rotated in the first direction, and supporting the second hinge shaft part, and
a second hinge shaft fixing part rack supporting a lower surface of the second hinge shaft fixing part and supported by the supportive structure.

9. The robot of claim 8, wherein the second hinge shaft fixing part comprises a pair facing each other at respective sides of the second hinge shaft part.

10. The robot of claim 8, wherein the second hinge shaft fixing part rack has a quadrangular plate shape.

11. The robot of claim 8, wherein the supportive structure includes legs supporting the hinge portion, and wherein the legs extend in a direction with an angle of 45° with respect to the first direction and the second direction.

12. The robot of claim 8, wherein the supportive structure is bent and extends in a direction away from the central axis of the hinge portion in the gravity direction.

13. The robot of claim 8,
wherein the supportive structure has at least four legs, and
wherein the at least four legs are hingedly-coupled to the pendulum.

14. The robot of claim 13, wherein the four legs are connected to each other at the lower end, and wherein a connected portion is supported by a base plate.

15. The robot of claim 8, further comprising a damper coupled between the pendulum portion and the supportive structure, the damper configured to reduce vibration between the pendulum portion and the tray.

16. The robot of claim 15, wherein the damper comprises:
a bracket fixed to an exterior circumferential surface of the pendulum mounting portion at the lower portion of the second hinge shaft part and installed to extend across a pair of second hinge shaft fixing parts,
an upper instrument fixed to the lower portion of the bracket and extending in a vertical direction to a length direction of the bracket,
a lower instrument fixed to an upper portion of the second hinge shaft fixing part rack, and extending in parallel to the upper instrument with a gap therebetween, and
a wire spring installed between the upper instrument and the lower instrument, and formed to have ring shapes arranged in parallel along length directions of the upper instrument and the lower instrument.

17. The robot of claim 16, wherein the upper instrument, the lower instrument, and the wire spring are provided as a pair symmetrically arranged to each other at the respective lower ends of the bracket.

18. A method for facilitating stability of an item while moving a robot, the method comprising:
supporting the item with a tray portion of the robot;
maintaining an orientation of the tray portion in a substantially vertical direction with respect to a gravity direction using a pendulum portion coupled to the tray portion;
providing a hinge portion, coupled to an upper end of the pendulum portion, the hinge portion having a multi-directional hinge-rotation with respect to the pendulum portion and the tray portion; and
damping a vibration of the pendulum portion and the tray portion using a damper coupled between the pendulum portion and a supportive structure.

19. The method of claim 18,
wherein maintaining the orientation includes providing a pendulum on the pendulum portion having a weight greater than a weight of the item supported on the tray portion, and
wherein the multi-directional hinge-rotation includes enabling hinge-rotation in a first direction using a first hinge shaft, and enabling hinge-rotation in a second direction perpendicular to the first direction using a second hinge shaft.

20. A robot comprising:
a tray configured for receiving an item;
a pendulum portion supporting the tray and configured to maintain the tray in a vertical direction with respect to a gravity direction;
a damping system for the pendulum portion comprising:
a bracket fixed to a pendulum mounting portion;
an upper fixture coupled to the bracket and extending in a first direction;
a lower fixture configured to be coupled to a support structure parallel to the upper fixture, defining a gap between the upper and lower fixtures; and
an elastic member disposed in the gap, the elastic member configured to provide a restoring force to facilitate maintaining a distance between the upper fixture and the lower fixture at least during a rotation of the pendulum mounting portion.
